(19) United States
(12) Patent Application Publication
(10) Pub. No.: US 2020/0410526 A1
(43) Pub. Date: Dec. 31, 2020

(54) INFORMATION MANAGEMENT DEVICE AND INFORMATION MANAGEMENT METHOD

(71) Applicant: HONDA MOTOR CO., LTD., Tokyo (JP)

(72) Inventor: Keiichi Takikawa, Tokyo (JP)

(21) Appl. No.: 16/976,538

(22) PCT Filed: Mar. 6, 2019
(86) PCT No.: PCT/JP2019/008833

§ 371 Date: Aug. 28, 2020

(30) Foreign Application Priority Data
Mar. 6, 2018 (JP) 2018-039648

(51) Int. Cl. G06Q 30/02; G06Q 50/28; B60L 53/62; B60L 53/65

(52) U.S. Cl. CPC G06Q 30/0239; G06Q 50/28; G06Q 2240/00; B60L 53/65; B60L 53/62

(57) ABSTRACT

Provided is an information management device with which it is possible to provide a benefit to a user of a moving body that was not able to use a charging apparatus for moving bodies, from among moving bodies that have visited a facility having the charging apparatus for moving bodies. An information management device (4) includes a stay determination unit (403), a charging determination unit (404), and a benefit information generation unit (405). The benefit information generation unit (405) generates benefit information related to a benefit to the user of a moving body determined by the stay determination unit (403) to have stayed in a facility and determined by the charging determination unit (404) to have not been charged by any of one or more charging apparatuses for moving bodies.

### TECHNICAL FIELD

The present invention relates to an information management device and an information management method.

### BACKGROUND ART

A technology for prompting a customer to visit a commercial facility has been proposed, in which a charging apparatus for electric vehicles (abbreviated and referred to as EVs or the like) is installed in a parking lot of the commercial facility to provide charging service free of charge or at low cost and to benefit according to the charging amount.

For example, Patent Literature 1 describes a communication device in a charging apparatus for vehicles provided in a facility having an information acquisition means, an information generation means, and an information transmission means.

From a portable terminal connected by wire or wirelessly to a charging apparatus for vehicles, the information acquisition means acquires portable information (an e-mail address or the like) for transmitting data to the portable terminal. The information generation means uses a vehicle in which a user is riding as a target vehicle, and generates benefit information for providing a user with a benefit that can be enjoyed in a facility according to the power supply amount measured during power supply (the charging amount in which the battery for travelling of the target vehicle is charged by the charging apparatus for vehicles). The information transmission means transmits the benefit information generated by the information generation means to the portable terminal using the portable information acquired by the portable information acquisition means.

According to the communication device, the benefit information is generated according to the charging amount in which the battery for travelling of the target vehicle in which the user is riding is charged by the charging apparatus for vehicles.

Then, the benefit information is transmitted to the portable terminal.

The benefit information is information for providing a benefit that is provided to the user and can be enjoyed in a facility. The user can enjoy the benefit in the facility by using the benefit information. Further, since the benefit information corresponds to the charging amount, it is possible to prompt the user to visit the facility that has the charging apparatus for vehicles so as to enjoy the benefit in the facility.

### CITATION LIST

### Patent Literature

Patent Literature 1: Japanese Patent Laid-Open No. 2013-246704

### SUMMARY OF INVENTION

### Technical Problem

However, since the charging apparatus for moving bodies such as vehicles is expensive and the electric power required for charging is enormous, it is practically difficult to install the charging apparatus for moving bodies in all parking spaces of a facility having a huge parking lot. When the charging apparatus installed in the parking lot is used by another moving body, it is not possible for a moving body parked in another parking space in the parking lot to be charged, resulting in a risk that the user of the moving body may feel dissatisfied and the image of the facility is damaged.

Even if any compensation is considered to be made to the user of the moving body that was not able to use a charging apparatus, in the prior art, it is not possible to identify a moving body that was not able to use a charging apparatus for moving bodies while it is possible to identify a moving body that used a charging apparatus for moving bodies based on the amount of power supply measured during power supply. For this reason, in the prior art, it has been difficult to make any compensation to the user of the moving body that was not able to use a charging apparatus.

Therefore, it is an object of the present invention to provide an information management device and an information management method capable of providing a benefit to a user of a moving body that was not able to use a charging apparatus of moving bodies, from among moving bodies that have visited a facility having the charging apparatus for moving bodies.

### Solution to Problem

The information management device of the present invention includes

a moving body information reception unit which receives moving body information that includes moving body identification information for identifying each of one or more moving bodies and moving body position information indicating a position of each of the one or more moving bodies,

a charging state information reception unit which receives charging state information indicating a charging state of a moving body by one or more charging apparatuses for moving bodies installed in a facility,

a facility information storage unit which stores facility information that includes at least a position of the facility,

a stay determination unit which determines whether a moving body has stayed in the facility based on the facility information and the moving body information.

a charging determination unit which determines whether the moving body determined to have stayed in the facility has been charged by any of the one or more charging apparatuses for moving bodies based on the charging state information that is received by the charging state information reception unit, and

a benefit information generation unit which generates benefit information related to a benefit to a user of the moving body determined by the stay determination unit to have stayed in the facility and determined by the charging determination unit to have not been charged by any of the one or more charging apparatuses for moving bodies.

According to the information management device, the benefit information related to a benefit is generated by the benefit information generation unit for a user of the moving body determined by the stay determination unit to have stayed in the facility and determined by the charging determination unit to have not been charged by any of the one or more charging apparatuses for moving bodies.

In this regard, there is a high probability that “the moving body determined by the stay determination unit to have stayed in the facility and determined by the charging determination unit to have not been charged by any of the one or more charging apparatuses for moving bodies” is a moving body that was not able to use the charging apparatus for mobile bodies, from among moving bodies that have visited the facility having the charging apparatus for moving bodies.

According to the information management device, since the benefit information for a user of a moving body of this kind is generated, it is possible to provide a benefit to the user of the moving body having a high probability of having not been able to use the charging apparatus for moving bodies, from among moving bodies that have visited the facility having the charging apparatus for moving bodies. As a result, it can be avoided that the user of the moving body that was not able to be charged by the charging apparatus of moving bodies feels dissatisfied or the image of the facility is damaged.

In the information management device of the present invention, it is preferable that the benefit information generation unit is configured to create the benefit information on a required condition that all of the one or more charging apparatuses for moving bodies are used by one or more moving bodies that are each different from the moving body detected by the stay determination unit to have stayed in the facility.

According to the information management device of the configuration, as one of the conditions under which the benefit information is created, it is necessary that all of the one or more charging apparatuses for moving bodies are used by one or more moving bodies that are each different from the moving body detected by the stay determination unit to have stayed in the facility.

Thereby, provision of a benefit is prevented in the case in which the necessity for providing a benefit is low, such as the case in which at least one of the one or more charging apparatuses for moving bodies is not used by another moving body but the user of the moving body does not use the charging apparatus for moving bodies due to his or her misidentification or choice.

In the information management device of the present invention, it is preferable that the benefit information is information for providing a benefit related to charging of a moving body.

According to the information management device of the configuration, a benefit related to charging of a moving body is provided to a user of the moving body that was not charged by the charging apparatus for moving bodies. Thereby, the imbalance between the user of the moving body that was charged by the charging apparatus for moving bodies and the user of the moving body that was not charged by the charging apparatus for moving bodies is corrected. As a result, it can be avoided that the user of the moving body that was not able to be charged by the charging apparatus for moving bodies feel dissatisfied or the image of the facility is damaged.

In the information management device of the present invention, it is preferable that the stay determination unit determines whether the moving body has stayed in the facility based on positions of the moving body at a plurality of points of time.

According to the information management device of the configuration, in determining whether the moving body has stayed in the facility, positions of the moving body at a plurality of points of time, which have a high probability of indicating whether the moving body has stayed in the facility, are used. Thereby, whether the moving body has stayed in the facility can be determined easily.

It is preferable that the stay determination unit determines whether the moving body has stayed in the facility based on a purchase history of a user of the moving body with respect to the facility.

According to the information management device of the configuration, in determining whether the moving body has stayed in the facility, a purchase history of a user of the moving body with respect to the facility, which has a high probability of indicating whether the moving body has stayed in the facility, is used. Thereby, whether the moving body has stayed in the facility can be determined easily.

In addition, in determining whether the moving body has stayed in the facility, which is a prerequisite for providing a benefit, not only a visit to the facility but also the existence or non-existence of a purchase in the facility am taken into account, thereby making it possible to further correspond to the needs on the side of the facility.

### BRIEF DESCRIPTION OF DRAWINGS

FIG. 1 is a diagram showing an overall structure of an embodiment of the present invention.

FIG. 2 is a diagram showing an example of a configuration of an on-board equipment.

FIG. 3 is a diagram showing an example of a configuration of a portable wireless terminal.

FIG. 4 is a diagram showing an example of a configuration of a server.

FIG. 5A is a diagram showing an example of user and moving body correspondence information.

FIG. 5B is a diagram showing an example of moving body information.

FIG. 6A is a diagram showing an example of benefit management information.

FIG. 6B is a diagram showing an example of charging facility information.

FIG. 6C is a diagram showing an example of charging state information.

FIG. 7A is a diagram showing a configuration of a facility terminal.

FIG. 7B is a diagram showing an example of a configuration of a charging apparatus for moving bodies.

FIG. 8A is a flowchart of an example of a moving body information reception process.

FIG. 8B is a flowchart of an example of a charging state information reception process.

FIG. 9 is a flowchart of an example of a benefit provision process.

FIG. 10A is a diagram describing an example of a period in which a charging apparatus is determined as being in use.

FIG. 10B is a diagram describing another example of a period in which the charging apparatus is determined as being in use.

FIG. 10C is a diagram describing that a stay start date and time is estimated from a purchase date and time.

FIG. 11 is a diagram showing an example of a purchase history.

FIG. 12 is a diagram showing an overall structure of another embodiment of the present invention.

FIG. 13 is a diagram showing an overall structure of yet another embodiment of the present invention.

### DESCRIPTION OF EMBODIMENTS

### First Embodiment

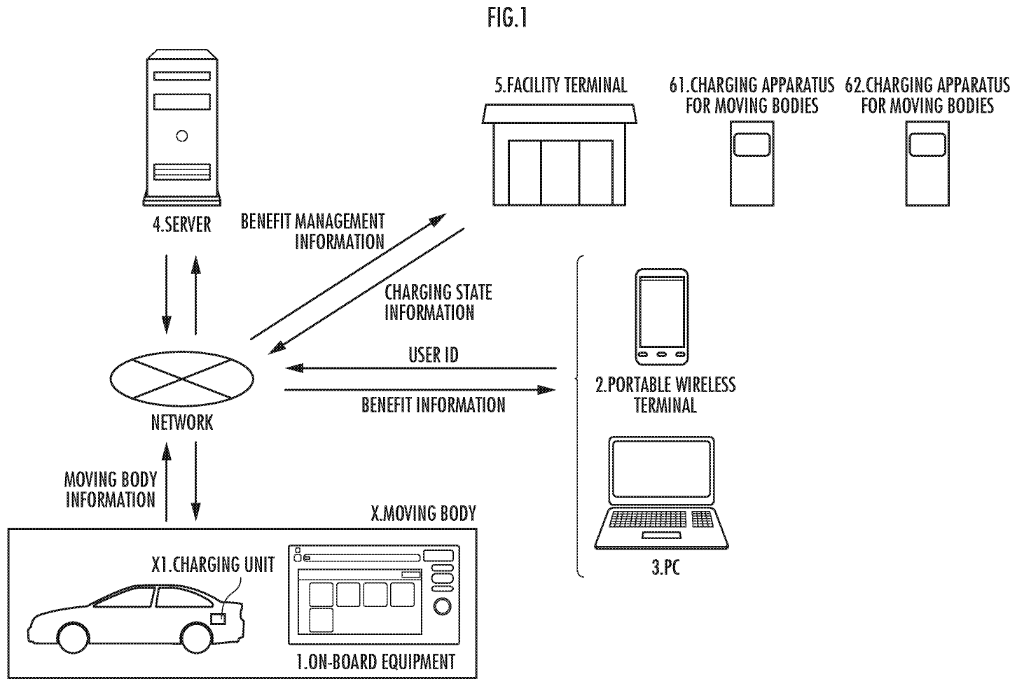

A first embodiment of the present invention will be described with reference to FIGS. 1 to 10B.

A basic system is configured to include an on-board equipment 1 mounted on a vehicle X (moving body), a portable terminal device 2 that can be brought into an interior of the vehicle X by an occupant (for example, a smartphone), a PC 3 installed at a home of the occupant, a server 4, a facility terminal 5, and a charging apparatuses for moving bodies 61 and 62. The on-board equipment 1, the portable terminal device 2, the PC 3, the server 4, the facility terminal 5, and the charging apparatuses for moving bodies 61 and 62 have a function of communicating with each other through a network (for example, the Internet or a wireless communication network). The on-board equipment 1 and the portable terminal device 2 have a function of wirelessly communicating with each other by a proximity wireless method (for example. Bluetooth (“Bluetooth” is a registered trademark)) when they am physically close to each other such as coexisting in the same space of the vehicle X. The vehicle X is an electric automobile and includes a charging unit X1 that can be connected to the charging apparatuses for moving bodies 61 and 62.

### (Configuration of the On-Board Equipment)

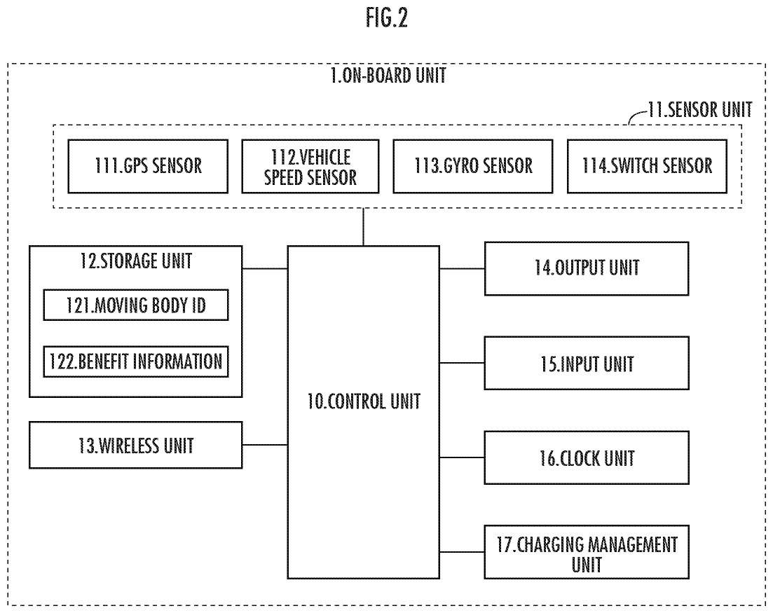

As shown in FIG. 2, the on-board equipment 1 includes a control unit 10, a sensor unit 11 (that is provided with a GPS sensor 111, a vehicle speed sensor 112, a gyro sensor 113, and a switch sensor 114), a storage unit 12, a wireless unit 13, an output unit 14, an input unit 15, a clock unit 16, and a charging management unit 17.

The control unit 10 is configured with an arithmetic device such as a CPU, for example. The arithmetic result of the arithmetic device is appropriately stored in the storage unit 12 and is read out in later processing. In order to allow signals to be input from the sensor unit 11, the storage unit 12, the wireless unit 13, the output unit 14, the input unit 15, the clock unit 16, and the charging management unit 17 and allow control signals to output to the sensor unit 11, the storage unit 12, the wireless unit 13, the output unit 14, the input unit 15, the clock unit 16, the charging management unit 17 and the like, the control unit 10 is connected to them via a BUS or the like.

The GPS sensor 111 of the sensor unit 11 calculates the current position based on a signal from a GPS (Global Positioning System) satellite. The vehicle speed sensor 112 calculates the speed of the vehicle X based on a pulse signal from a rotating shaft. The gyro sensor 113 detects an angular velocity. Because of the GPS sensor, the vehicle speed sensor, and the gym sensor, it is possible to accurately calculate the current position and the orientation of the vehicle X.

The switch sensor 114 is configured to output a signal indicating whether a switch of a driving source of the vehicle X on which the on-board equipment 1 is mounted is in an ON state or in an OFF state.

The storage unit 12 is configured with a storage device such as a memory or an HDD.

The storage unit 12 is configured to store a moving body ID121 as moving body identification information for identifying the vehicle X and benefit information 122 received from the server 4 or the like.

The wireless unit 13 is configured with a communication device that performs wireless communication such as Wi-Fi: Wireless Fidelity (registered trademark), Bluetooth (registered trademark), 3G, cellular, and LTE communications.

The output unit 14 is configured with, for example, an image display device such as a liquid crystal display and a sound output device such as a speaker. The output unit 14 is configured to output information such as an image or a sound corresponding to a control signal from the control unit 10 in a form that can be recognized by an occupant of the vehicle X through the five senses.

The input unit 15 is configured, for example, with a device capable of receiving an input of information, such as an operation reception device including a touch panel and a voice input device. The input unit 15 appropriately performs signal conversion or the like on the input information and outputs the information to the control unit 10.

The clock unit 16 is configured to be able to recognize a date and a time. The clock unit 16 is configured to be able to synchronize the time with an NTP (Network Time Protocol) server by communicating with the NTP server, for example.

It should be noted that one device “recognizes” information means all arithmetic operations to obtain the information are executed, such as receiving the information by one device from another device, reading information stored in a storage medium connected to the one device by one device, obtaining information by one device based on a signal output from a sensor connected to the one device, deriving the information by one device by executing a predetermined arithmetic operation (such as a calculation operation or a search operation) based on received information, information stored in a storage medium, or information obtained from a sensor, receiving the information by one device from another device as a result of an arithmetic operation by the other device, and reading the information by one device from an internal storage device or an external storage device according to the received signal.

The charging management unit 17 is configured to obtain a charging state of the vehicle X, and identification information for identifying a charging apparatus connected to the charging unit X1 of the vehicle X by communicating with the vehicle X.

### (Configuration of the Portable Terminal Device)

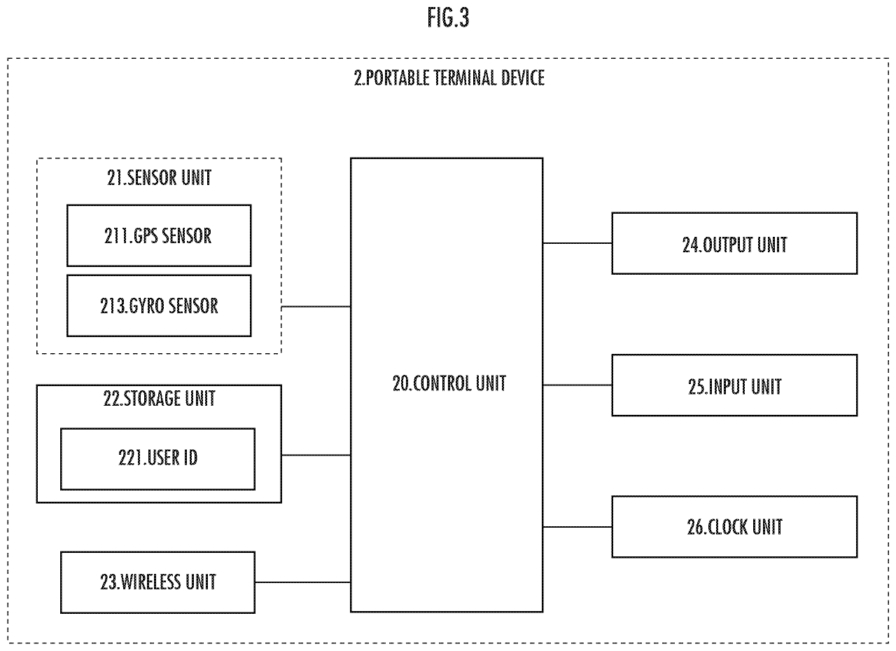

As shown in FIG. 3, for example, the portable terminal device 2 includes a control unit 20, a sensor unit 21 (that is provided with a GPS sensor 211 and a gyro sensor 213), a storage unit 22, a wireless unit 23, and an output unit 24, an input unit 25, and a clock unit 26.

The storage unit 22 is configured with, for example, a memory or a hard disk, and stores a user ID 221 that is identification information for identifying a user of the portable terminal device 2. The user ID 221 is, for example, an email address of the user.

As the control unit 20, the sensor unit 21, the wireless unit 23, the output unit 24, the input unit 25, and the clock unit 26 of the portable terminal device 2 have substantially the same configuration and function as each component of the on-board equipment 1, the descriptions thereof are omitted in the present description. Though the portable terminal device 2 does not include a component element to obtain the charging state information (refer to FIG. 2/the charging management unit 17), it is possible to obtain the charging state information from the on-board equipment 1 through the wireless unit 23, for example. Furthermore, the portable terminal device 2 may be provided with the function similar to each of the charging management unit 17 of the on-board equipment 1 according to an application (software) stored in the storage unit 22. In addition, the portable terminal device 2 may be configured to recognize an ON state or an OFF state of the switch of the driving source of the vehicle X by communicating with the vehicle X.

### (Configuration of the PC)

The PC 3 has substantially the same configuration as the portable terminal device 2.

### (Configuration of the Server)

The server 4 is configured with a server computer, for example. The server corresponds to an example of the “information management device” of the present invention.

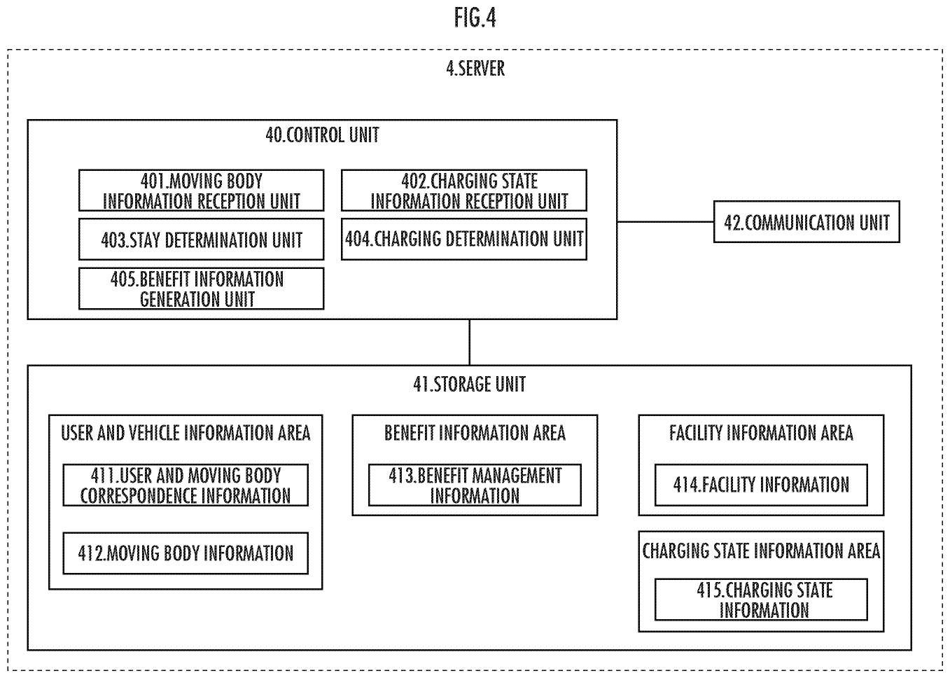

As shown in FIG. 4, the server 4 includes a control unit 40, a storage unit 41, and a communication unit 42. The storage unit 41 corresponds to an example of a “facility information storage unit” of the present invention.

The control unit 40 is configured with an arithmetic device such as a CPU, for example. The arithmetic result of the arithmetic device is appropriately stored in the storage unit 41 and is read out in later processing. In order to allow signals to be input from the storage unit 41 and the communication unit 42 and to allow control signals to output to the storage unit 41, the communication unit 42 and the like, the control unit 40 is connected to them via a BUS or the like. By executing a predetermined program stored in the storage unit 41, the control unit 40 functions as a moving body information reception unit 401, a charging state information reception unit 402, a stay determination unit 403, a charging determination unit 404, and a benefit information generation unit 405 that execute later processing.

The storage unit 41 is configured with a storage device such as a memory and an HDD, for example. The storage unit 41 stores user and moving body correspondence information 411, moving body information 412, benefit management information 413, facility information 414, and charging state information 415.

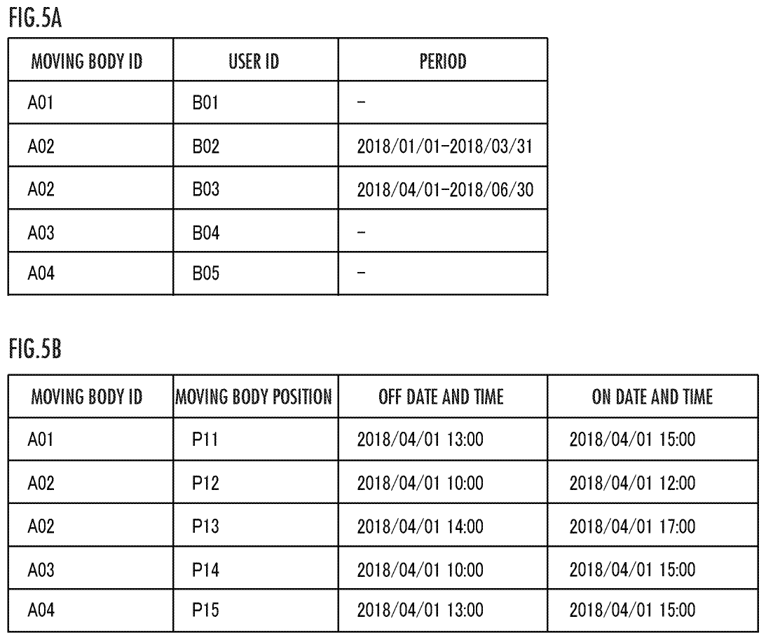

The user and moving body correspondence information 411 is information that includes a moving body ID and a user ID, as shown in FIG. 5A.

For example, in FIG. 5A, a moving body ID “A01” and a user ID “B01” are associated with each other. This means that a moving body identified by the moving body ID “A01” is used, borrowed, or owned by a user identified by the user ID “B01”.

As in the case of the moving body ID “A02” shown in FIG. 5A, a plurality of user IDs may be associated with one moving body ID. In this case, as shown in FIG. 5A, a period may also be associated with each user ID. This means that a user identified by each of user IDs “B02” and “B03” uses, borrows, or owns the target moving body ID “A02” in a period associated with the user ID.

The moving body ID, the user ID, and the period may be set based on information received from the portable terminal device 2 or the PC 3, for example.

As shown in FIG. 5B, the moving body information 412 is information that includes a moving body ID, moving body position information indicating a position of the moving body identified by the moving body ID, an OFF date and time that is a date and time when the switch of the driving source of the moving body is turned off, and an ON date and time that is a date and time when the switch of the driving source of the moving body is turned on for the first time after the OFF date and time. The moving body position information is represented by, for example, a latitude and a longitude obtained by the GPS sensor 111 or the like. The moving body position information may further include a height.

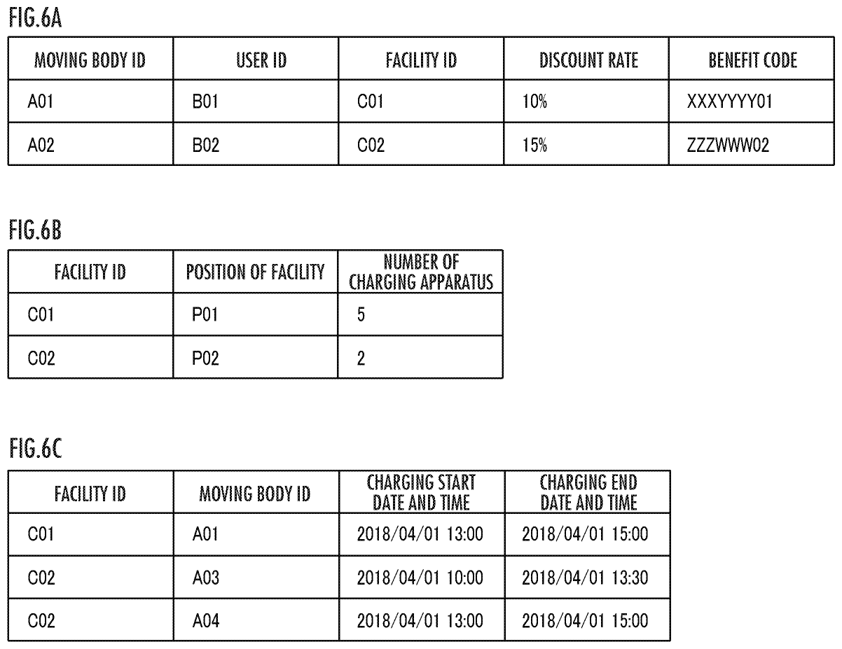

As shown in FIG. 6A, the benefit management information 413 is information that includes a moving body ID, a user ID, a facility ID, a discount rate, and a benefit code. The benefit management information is information indicating that for a specific or non-specific service or a product such as charging in a facility identified by the facility ID, a user identified by the user ID (a user who has used a moving body identified by the moving body ID) can enjoy a discount at a rate indicated by the discount rate (which corresponds to the “benefit” of the present invention). The benefit code is information for specifying the benefit. Using the portable terminal device 2, a user can enjoy a benefit specified by the benefit code by causing the benefit code to be read using the facility terminal, the charging apparatus for moving bodies, or the like of the facility. Note that the benefit is not limited to the discount rate, but may be a chargeable amount. In this case, the benefit management information includes information indicating the chargeable amount such as the amount of electric power and the charging time.

As shown in FIG. 6B, the facility information 414 is information that includes a facility ID, a position of a facility identified by the facility ID, and the number of charging apparatuses for moving bodies that the facility has. The position of the facility is represented by a latitude and a longitude as in the case of the moving body position information. The position of the facility may further include a height. The position of the facility may indicate one position of the facility, for example, the position of the center of the facility or the like, but may be represented by a range having a certain extent such as a position of the parking lot. Information received fom the facility terminal 5 or the like may be stored as the facility information 414.

As shown in FIG. 6C, the charging state information 415 is information that includes a facility ID, a moving body ID, a charging start date and time that is a date and time when the moving body identified by the moving body ID starts charging in the facility identified by the facility ID, and a charging end date and time that is a date and time when the moving body finishes charging for the first time after the charging start date and time.

The communication unit 42 is configured to be able to communicate with each of the on-board equipment 1, the portable terminal device 2, the PC 3, the facility terminal 5, and the charging apparatuses for moving bodies 61 and 62 via a network by wired communication or wireless communication.

### (Configuration of the Facility Terminal)

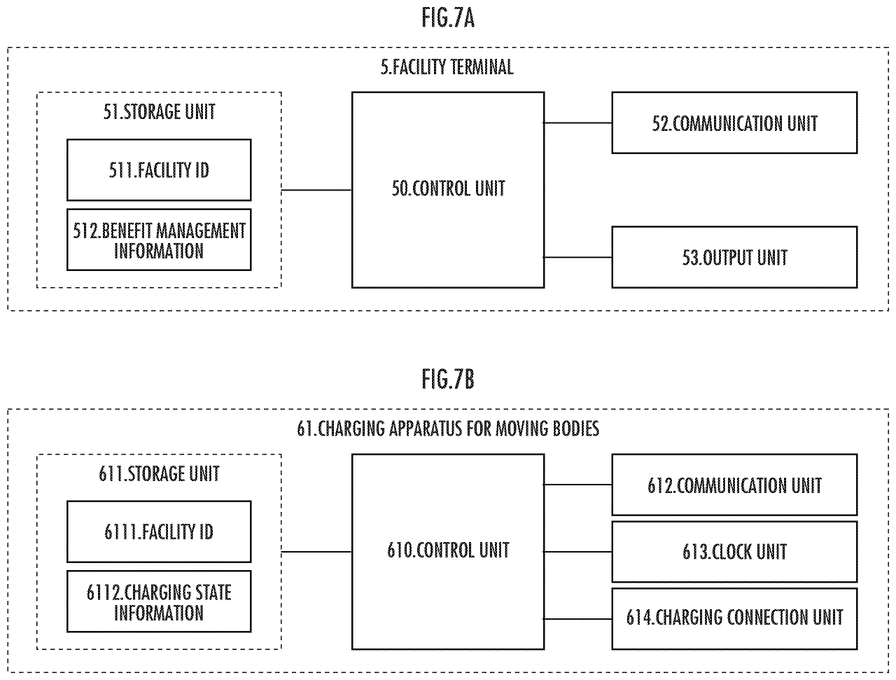

As shown in FIG. 7A, the facility terminal 5 includes a control unit 50, a storage unit 51, a communication unit 52, and an output unit 53. The storage unit 51 is configured with a storage device such as a memory and an HDD, for example, and stores a facility ID for identifying a facility that owns or uses the facility terminal 5 and management information of the benefit that can be used in the facility. The control unit 50, the communication unit 52, and the output unit 53 each has the same configuration as the control unit, the communication unit, and the output unit of the on-board equipment 1, the portable terminal device 2, or PC3, respectively.

### (Configuration of the Charging Apparatus for Moving Bodies)

As shown in FIG. 7B, the charging apparatus for moving bodies 61 includes a control unit 610, a storage unit 611, a communication unit 612, a clock unit 613, and a charging connection unit 614. The storage unit 611 stores a facility ID 6111 and charging state information 61112 that indicates a charging state of the moving body in the charging apparatus for moving bodies 61. The charging connection unit 614 is configured to be connectable to the charging unit X1 of the moving body (vehicle X). The control unit 610, the communication unit 612, and the clock unit 613 each has the same configuration as the control unit, the communication unit, and the clock unit of the on-board equipment 1, the portable terminal device 2, or the PC 3, respectively.

### (Moving Body Information Reception Process)

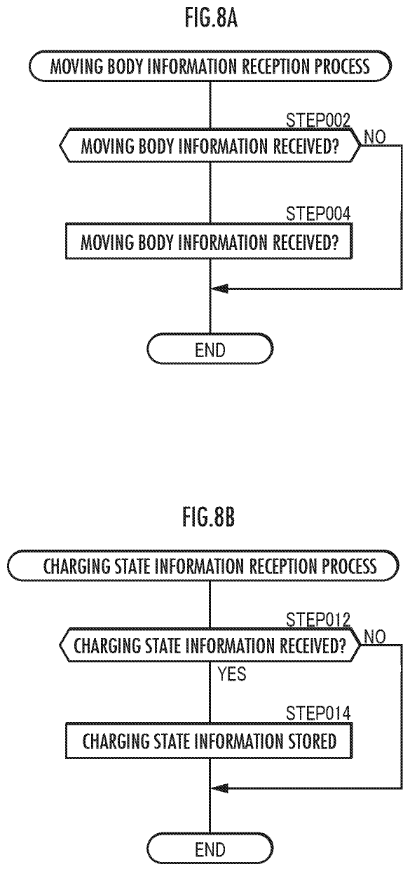

Next, with reference to FIG. 8A, a moving body information reception process will be described. The moving body information reception process is periodically and repeatedly executed by the control unit 40 of the server 4.

The control unit 40 (the moving body information reception unit 401) of the server 4 determines whether moving body information is received from the on-board equipment 1 of the moving body (vehicle X)(FIG. 8A/STEP002). The moving body information is transmitted, for example, at the timing when it is detected that the switch of the driving source of the moving body (vehicle X) is turned on. The moving body information is information that includes the moving body ID stored in the storage unit 12 of the on-board equipment 1, the moving body position information of the moving body (vehicle X) recognized by the sensor unit 11 of the on-board equipment 1, the OFF date and time that is a date and time when the switch of the driving source of the moving body (vehicle X) recognized by the sensor unit 11 of the on-board equipment 1 is turned off, and the ON date and time that is a date and time when the switch of the driving source of the moving body (vehicle X) recognized by the sensor unit 11 of the on-board equipment 1 is turned on.

If the determination result is affirmative (FIG. 8A/STEP002 . . . YES), the control unit 40 (the moving body information reception unit 401) of the server 4 adds the received information to the moving body information 412 of the storage unit 41 (refer to FIG. 5B) and then stores the information (FIG. 8B/STEP014).

If the determination result is negative (FIG. 8A/STEP002 . . . NO), the control unit 40 of the server 4 finishes the processing.

(Charging state information reception process)

Next, with reference to FIG. 8B, a charging state information reception process will be described. The charging state information reception process is periodically and repeatedly executed by the control unit 40 of the server 4.

The control unit 40 (the charging state information reception unit 402) of the server 4 determines whether the charging state information is received from the charging apparatuses for moving bodies 61 and 62 via the communication unit 42 (FIG. 8B STEP012). The charging state information is transmitted, for example, at the timing when charging of one moving body is started or charging thereof is completed. The charging state information is information that includes the facility ID stored in the storage unit of the charging apparatus of moving bodies, the moving body ID that identifies the one moving body obtained via the charging connection unit, the charging start date and time indicated in the clock unit at the time when the charging connection unit starts charging, and the charging end date and time detected by the clock unit at the time when the charging connection unit finished charging.

If the determination result is affirmative (FIG. 8B/STEP012 . . . YES), the control unit 40 (the charging state information reception unit 402) of the server 4 adds the received information to the charging state information 415 of the storage unit 41 (refer to FIG. 6C) and stores the information (FIG. 8B/STEP014).

If the determination result is negative (FIG. 8B/STEP012 . . . NO), the control unit 40 of the server 4 finishes the processing.

### (Benefit Provision Process)

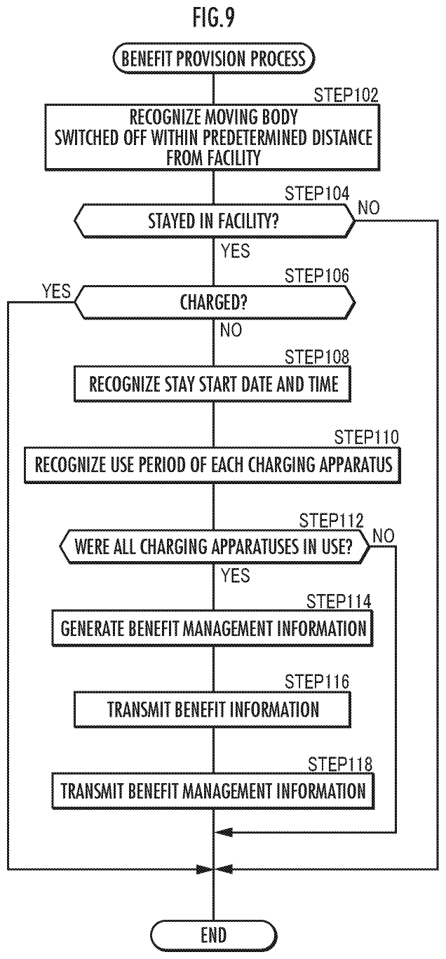

Next, with reference to FIG. 9, a benefit provision process will be described. The benefit provision process is periodically and repeatedly executed by the control unit 40 of the server 4.

Based on the moving body information 412 and the facility information 414, the control unit 40 (the stay determination unit 403) of the server 4 recognizes a moving body ID of the moving body that is switched off within a predetermined distance from any facility (FIG. 9/STEP102). For example, the control unit 40 (the stay determination unit 403) of the server 4 recognizes a position that is within a predetermined distance from positions “P01” and “P02” of each facility indicated in the facility information 414 (refer to FIG. 6B), from among the moving body position information “P11” to “P15” included in the moving body information 412 (refer to FIG. 5B). The control unit 40 (the stay determination unit 403) of the server 4 also recognizes the facility ID of a facility that is within a predetermined distance from the position of the moving body. Note that, when the control unit 40 of the server 4 recognizes a plurality of positions, the processing of FIG. 9/STEP104 and the subsequent steps may be repeatedly executed for each position. Also, the predetermined distance in FIG. 9/STEP102 may be a uniformly specified distance or a distance specified for each facility. In addition, when the position of the facility is indicated by a range having a certain extent, alternately or additionally to the determination whether it is within a predetermined distance, the control unit 40 of the server 4 may recognize the position of a moving body included in the range.

The control unit 40 (the stay determination unit 403) of the server 4 determines whether the moving body identified by the moving body ID recognized in FIG. 9/STEP102 (hereinafter, referred to as “target moving body”) has stayed in a facility within a predetermined distance from the position of the moving body (hereinafter, referred to as “target facility”)(FIG. 9/STEP04). For example, the control unit 40 (the stay determination unit 403) of the server 4 refers to the moving body information 412, and then determines whether a gap between the OFF date and time and the ON date and time of the recognized moving body ID is longer than a predetermined period of time (that is, the moving body has stayed). The predetermined period of time may be a period of time specified for each facility, or may be a period of time uniformly specified.

If the determination result is negative (FIG. 9/STEP104 . . . NO), the control unit 40 of the server 4 finishes the processing.

If the determination result is affirmative (FIG. 9/STEP104 . . . YES), the control unit 40 (the charging determination unit 404) of the server 4 determines whether the target moving body has been charged in at least a part of the period from the OFF time to the ON time based on the moving body information 412 and the charging state information 415 (FIG. 9/STEP106).

The control unit 40 (the charging determination unit 404) of the server 4 determines, for example, whether the period “2018/04/01 13:00 to 15:00” from the OFF time to the ON time of the moving body ID “A01” indicated in the moving body information 412 (FIG. 5B) overlaps with the charging period “2018/04/01 13:00 to 15:00” of the moving body ID “A01” indicated in the charging state information 415 (FIG. 6) (that is, the charging has been performed).

In examples shown in FIG. 5B and FIG. 6C, the determination results of the moving bodies “A01”, “A03”, and “A04” are affinnative in FIG. 9/STEP106, and the determination results of the moving body “A02” is negative in the period from any OFF time to the ON time in FIG. 9/STEP106.

If the determination result is affirmative (FIG. 9/STEP106 . . . NO), the control unit 40 of the server 4 finishes the processing.

If the determination result is negative (FIG. 9/STEP106 . . . NO), the control unit 40 (the benefit information generation unit 405) of the server 4 recognizes a stay start date and time of the target moving body in the target facility (FIG. 9/STEP108). For example, the control unit 40 (the benefit information generation unit 405) of the server 4 recognizes the OFF dates and times “2018/04/01 10:00” and “2018/04/01 14:00” of the moving body ID “A02” indicated in the moving body information 412 (FIG. 5B), as stay start dates and times, respectively.

The control unit 40 (the benefit information generation unit 405) of the server 4 recognizes a use period of the charging apparatus in the target facility (FIG. 9/STEP110). For example, the control unit 40 (the benefit information generation unit 405) of the server 4 recognizes, as the use period of the charging apparatus, a period from an earlier date and time between the charging start date and time and the OFF date and time associated with each moving body ID included in the charging state information 415 to a later date and time between the charging end date and time and the ON date and time associated with the moving body ID based on the moving body information 412 and the charging state information 415. This is because such cases are assumed as the case in which it takes time to start charging even after the switch is turned off, the case in which the switch is not turned off for some reason even after charging is started, the case in which charging ends before the occupant returns, and the case in which the switch is turned on because one of the occupants has returned but the moving body does not depart and charging continues until the remaining occupant returns.

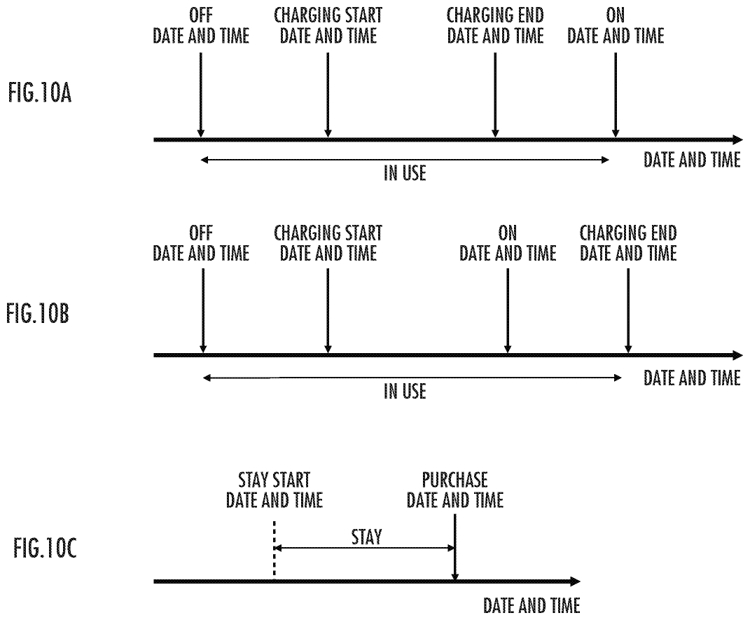

For example, as shown in FIG. 10A, if the OFF date and time is earlier than the charging start date and time and the ON date and time is later than the charging end date and time, the control unit 40 (the benefit information generation unit 405) of the server 4 recognizes a period from the OFF date and time to the ON date and time as a use period of the charging apparatus.

Further, as shown in FIG. 10B, if the OFF date and time is earlier than the charging start date and time and the charging end date and time is later than the ON date and time, the control unit 40 (the benefit information generation unit 405) of the server 4 recognizes the period from the OFF date and time to the charging end date and time as a use period of the charging apparatus.

For example, with respect to the moving body ID “A03”, the ON date and time “2018/04/01 15:00” indicated in the moving body information 412 (refer to FIG. 5B) is later than the charging end date and time “2018/04/01 13:30” indicated in the charging state information 415 (refer to FIG. 6C). In this case, the control unit 40 (the benefit information generation unit 405) of the server 4 recognizes the ON date and time “2018/04/01 15:00” as an end of the use period of the charging apparatus.

The control unit 40 (the benefit information generation unit 405) of the server 4 determines whether all charging apparatuses in the target facility were in use (during the use period) at the stay start date and time of the target moving body recognized in FIG. 9/STEP108 (FIG. 9/STEP112). For example, the control unit 40 (the benefit information generation unit 405) of the server 4 determines whether the number of charging apparatuses in use in the target facility is equal to the number of the charging apparatuses associated with the facility ID of the target facility indicated in the facility information 414 (that is, all charging apparatuses in the target facility are in use) at the stay start date and time of the target moving body recognized in FIG. 9/STEP108.

For example, it is assumed that the facility ID of the target facility is “C02” and the moving body ID of the target moving body is “A02”. In the facility whose facility ID is “C02”, with respect to the moving body ID “A03”, “2018/04/01 10:00 to 15:00” is the use period of one charging apparatus, and with respect to the moving body ID “A04”, “2018/04/01 13:00 to 15:00” is the use period of one charging apparatus.

In this case, in the stay start date and time “2018/04/01 10:00” of the target moving body whose moving body ID is “A02”, use of the charging apparatus with respect to the moving body ID “A04” has not started. Therefore, the number of the charging apparatus used in the facility whose facility ID is “C02” is 1, which is the charging apparatus used by the moving body ID “A03”. This number is smaller than “2” that is the number of the charging apparatuses of the facility ID “C02” indicated in the facility information 414. Accordingly, the control unit 40 (the benefit information generation unit 405) of the server 4 determines that not all charging apparatuses were in use in the facility whose facility ID is “C02” at the stay start date and time “2018/04/01 10:00” of the target moving body whose moving body ID is “A02” (FIG. 9/STEP112 . . . NO).

On the other hand, the stay start date and time “2018/04/01 14:00” of the target moving body whose moving body ID is “A02” is included in any of the use period “2018/04/01 10:00 to 15:00” of the moving body ID “A03” and the use period “2018/04/01 13:00 to 15:00” of the moving body ID “A04”.

Accordingly, the number of charging apparatuses used in the facility whose facility ID is “C02” is 2 at the stay start date and time “2018/04/01 14:00” of the target moving body whose moving body ID is “A02”. Accordingly, the control unit 40 (the benefit information generation unit 405) of the server 4 determines that all charging apparatuses in the facility whose facility ID is “C02” were in use at the stay start date and time “2018/04/01 14:00” of the target moving body whose moving body ID is “A02” (FIG. 9/STEP12 . . . YES).

If the determination result is negative (FIG. 9/STEP112 . . . NO), the control unit 40 of the server 4 finishes the processing.

If the determination result is affirmative (FIG. 9/STEP112 . . . YES), the control unit 40 (the benefit information generation unit 405) of the server 4 generates the benefit management information (FIG. 9/STEP114).

For example, the control unit 40 (the benefit information generation unit 405) of the server 4 refers to a table or the like, for example, and then determines a discount rate according to the length of the period from the OFF date and time to the ON date and time of the target moving body. The control unit 40 (the benefit information generation unit 405) of the server 4 refers to the user and moving body correspondence information 411, and then recognizes the user ID associated with the moving body ID of the target moving body at the stay start date and time. For example, the control unit 40 (the benefit information generation unit 405) of the server 4 refers to the user and moving body correspondence information 411 (FIG. 5A), and then recognizes the user ID “B03” associated with the moving body ID “A02” of the target moving body at the stay start date and time “2018/04/01 14:00”.

Then, the control unit 40 (the benefit information generation unit 405) of the server 4 issues a benefit code that indicates a moving body ID of the target moving body, a facility ID of the target facility, the user ID, and a discount rate, and then generates the benefit management information. The control unit 40 (the benefit information generation unit 405) of the server 4 adds the generated information to the benefit management information 413 and stores the information.

The control unit 40 (the benefit information generation unit 405) of the server 4 transmits the benefit information that includes the discount rate and the benefit code included in the benefit management information to a contact address (for example, an email address indicated in the user ID) associated with the user ID that is associated with the moving body ID of the target moving body at the stay start date and time via the communication unit 42 (FIG. 9/STEP116). The user to whom the benefit is provided can confirm the benefit information via the output unit 24 or the like of his or/her portable terminal device 2, or have a person in charge of the facility confirm the benefit information.

Furthermore, the control unit 40 (the benefit information generation unit 405) of the server 4 transmits the benefit management information to a contact address associated with the facility ID of the target facility via the communication unit 42 (FIG. 9/STEP118). The person in charge of the facility can confirm the benefit management information via the output unit 53 of the facility terminal 5 of the facility.

Benefit provision is carried out through the above processing.

### Operational Effect of the Present Embodiment

Hereinafter, for the convenience of description, the moving body or the like identified by the moving body ID “A02” or the like is simply referred to as the moving body “A02” or the like.

According to the information management device (the server 4), to a user “B03” of the moving body “A02” that is determined by the stay determination unit 403 (the control unit 40) to have stayed in the facility (FIG. 9/STEP104 . . . YES) and determined by the charging determination unit 404 (the control unit 40) to have not been charged by any of the one or more charging apparatuses for moving bodies (FIG. 9/STEP106 . . . NO), the benefit information generation unit 405 (the control unit 40) generates benefit information related to a benefit (FIG. 9/STEP114). Note that the benefit information related to a benefit may be information itself when the information itself is of value, such as an image, voice information or the like of a character, or may be information for enjoying a benefit such as a code for receiving charging or a code for receiving a discount for charging.

In this regard, there is a high probability that “a moving body that is determined by the stay determination unit 403 to have stayed in the facility and determined by the charging determination unit 404 to have not been charged by any of the one or more charging apparatuses for moving bodies” is a moving body that was not able to use the charging apparatus for moving bodies, from among the moving bodies “A02”, “A03”, and “A04” that have visited the facility “C02” having the charging apparatuses for moving bodies.

According to the information management device (the server 4), since benefit information is generated for the user “B03” of the moving body “A02” of this kind, it is possible to provide a benefit to a user of a moving body having a high probability to have not been able to use the charging apparatus for moving bodies, from among moving bodies that have visited the facility having the charging apparatus for moving bodies. As a result, it can be avoided that the user of the moving body that was not able to be charged by the charging apparatus for moving bodies feels dissatisfied or the image of the facility is damaged.

According to the information management device (the server 4) of the configuration, as one of the conditions for the benefit information to be created, all of the one or more charging apparatuses for moving bodies are used by the one or more moving bodies “A03” and “A04” that are each different from the moving body “A02” detected by the stay detection unit to have stayed in the facility (FIG. 9/STEP112 . . . YES).

Accordingly, provision of a benefit is prevented in the case in which the necessity for providing a benefit is low, such as the case in which at least one of the one or more charging apparatuses for moving bodies is not used by another moving body (in the case of the stay start date and time “2018/04/01 10:00”) but the user of the moving body does not use the charging apparatus for moving bodies due to his or her misidentification or choice.

According to the information management device (the server 4) of the configuration, a benefit related to charging of a moving body is provided to the user “B03” of the moving body “A02” that was not charged by the charging apparatus for the moving bodies (FIG. 9/STEP114). Thereby, the imbalance between the user of the moving body that was charged by the charging apparatus for moving bodies and the user of the moving body that was not charged by the charging apparatus for moving bodies is corrected. As a result, it can be avoided that the user of the moving body that was not able to be charged by the charging apparatus for moving bodies feels dissatisfied or the image of the facility is damaged.

According to the information management device (the server 4) of the configuration, when whether the moving body has stayed in the facility is determined, positions of the moving body at a plurality of points of time (positions of the moving body at the OFF date and time and the ON date and time), which have a high probability of indicating whether the moving body has stayed in the facility, are used (FIG. 9/STEP104). Thereby, whether the moving body has stayed in the facility can be determined easily.

### Second Embodiment

With reference to FIGS. 1 to 11 as appropriate, a second embodiment that uses a purchase history in a target facility in determining whether a moving body has stayed in the facility will be described. The purchase history is, for example, transmitted from the facility terminal 5 to the server 4 and stored in the storage unit 41 of the server 4.

The configuration and processing common to those of the first embodiment are denoted by the same reference numerals and the descriptions thereof are omitted.

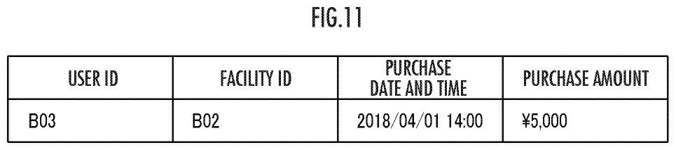

In STEP104 of FIG. 9, the control unit 40 (the stay determination unit 403) of the server 4 refers to, for example, a purchase history as shown in FIG. 11, the user and moving body correspondence information 411, and the moving body information 412, and then determines whether there has been a purchase with the user ID associated with a target moving body between an OFF date and time and an On date and time of the target moving body. In the examples shown in FIGS. 5A, 5B, and 11, the control unit 40 (the stay determination unit 403) of the server 4, for example, for a target moving body “A02”, determines that there has been a purchase history “2018/04/01 14:00 5,000 yen” with the user ID “B03” associated with the target moving body between “2018/04/01 13:00-15:00” that is from the OFF date and time to the ON date and time of the target moving body, and then evaluates the determination result of STEP104 of FIG. 9 as affirmative.

In this case, as shown in FIG. 10C, for example, the control unit 40 (the benefit information generation unit 405) of the server 4 may recognize, from the purchase time in STEP108 of FIG. 9, the stay start date and time of the moving body “A02” as a period before a predetermined time.

Further, the control unit 40 (the benefit information generation unit 405) of the server 4 may determine the details of the benefit such as a discount rate according to the purchase price of the user “B03” in STEP114 of FIG. 9.

According to the information management device (server 4) of the second embodiment, in determining whether the moving body “A02” has stayed in the facility “C02” (FIG. 9/STEP104), the purchase history of the user “B03” of the moving body with respect to the facility, which has a high probability of indicating whether the moving body has stayed in the facility, is used (FIG. 11). Thereby, whether the moving body has stayed in the facility can be determined easily.

Further, in determining whether the moving body has stayed in the facility, which is a prerequisite for providing a benefit, not only a visit to the facility “C02” but also the existence or non-existence of a purchase in the facility am taken into account, thereby making it possible to further correspond to the needs on the side of the facility “C02”.

### (Modifications)

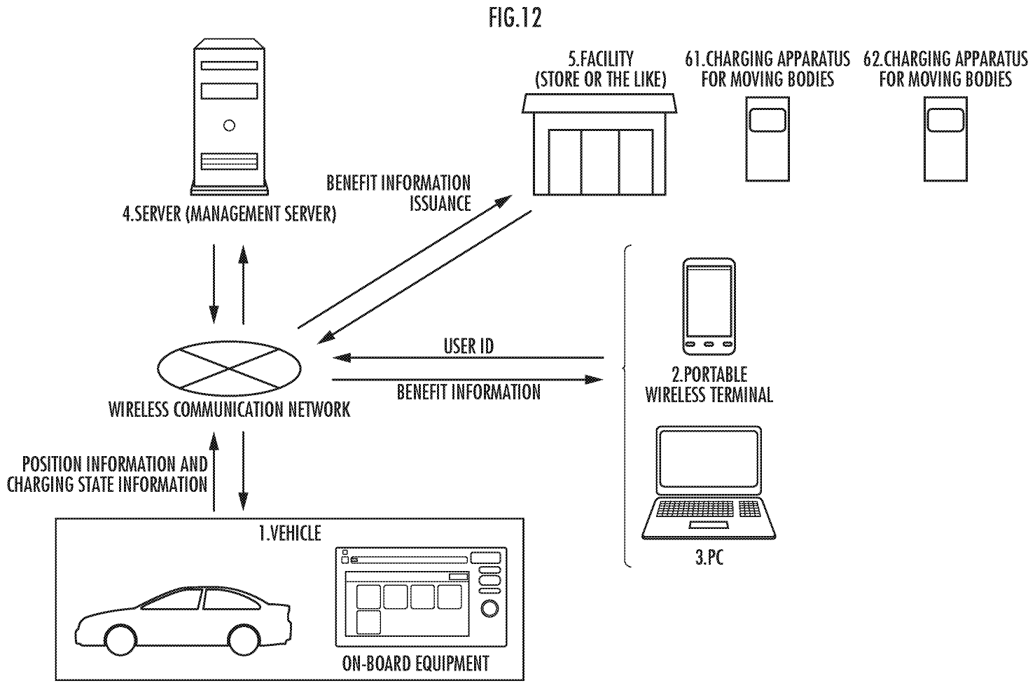

As shown in FIG. 12, the server 4 may receive the charging state information from the moving body (vehicle X) in FIG. 8B/STEP012.

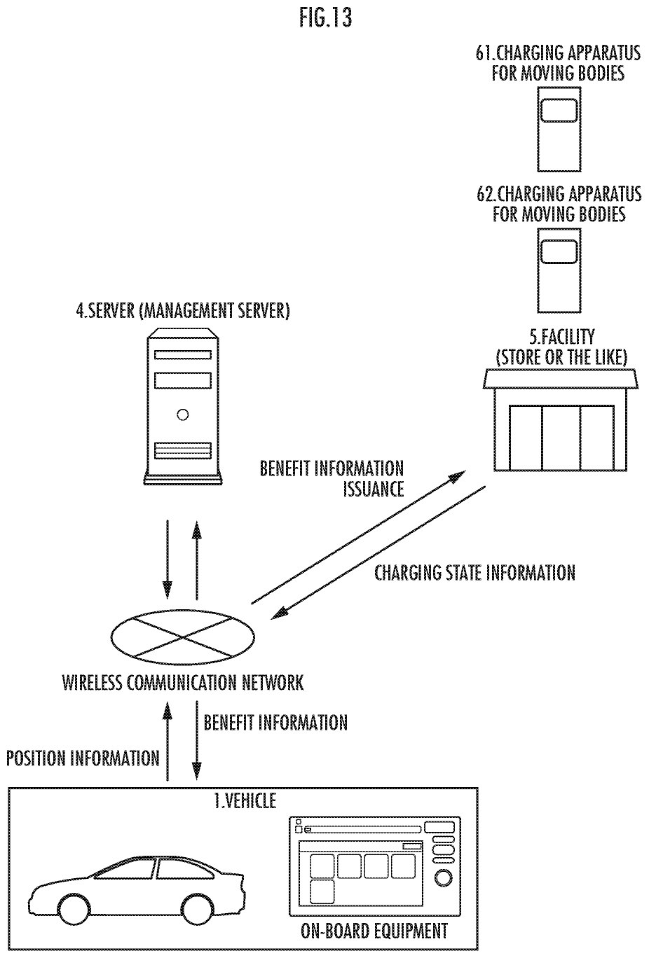

Further, as shown in FIG. 13, the server 4 may transmit the benefit information to the vehicle X in FIG. 9/STEP116. In this case, the benefit information can be output to the output unit 14 of the on-board equipment 1.

The benefit is not necessarily limited to a discount at a certain rate, and may be a discount of a certain amount, may be a benefit that allows a user to enjoy an additional service, or may be a benefit that allows a user to receive an additional gift.

It should be noted that the benefit information is not necessarily transmitted, and the server 4 having a billing function may refer to the benefit management information 413, and then automatically applies a benefit such as a discount to the next billing amount of a user to whom the benefit is provided (a user identified by the user ID included in the benefit management information).

In addition, a place where the benefit can be enjoyed is not necessarily limited to a single facility, and may be a related facility (for example, a charging station having an agreement with the target facility (a facility having a facility ID associated with the target facility ID)). In this case, the benefit management information may be transmitted to a contact address specified by the facility ID of the related facility.

Furthermore, with respect to a benefit related to charging, a benefit such as a discount may be enjoyed even by a moving body different from the target moving body by applying the benefit to it on condition that their user IDs or the benefit codes are matched.

### REFERENCE SIGNS LIST

4 Server (Information management device)
401 Moving body information reception unit
402 Charging state information reception unit
403 Stay determination unit
404 Charging determination unit
405 Benefit information generation unit
41 Storage unit (Facility Information storage unit)

1. An information management device, comprising:
a moving body information reception unit which receives moving body information that includes moving body identification information for identifying each of one or more moving bodies and moving body position information indicating a position of each of the one or more moving bodies;
a charging state information reception unit which receives charging state information indicating a charging state of a moving body by one or more charging apparatuses for moving bodies installed in a facility;
a facility information storage unit which stores facility information that includes at least a position of the facility;
a stay determination unit which determines whether a moving body has stayed in the facility based on the facility information and the moving body information;
a charging determination unit which determines whether the moving body determined to have stayed in the facility has been charged by any of the one or more charging apparatuses for moving bodies based on the charging state information that is received by the charging state information reception unit; and
a benefit information generation unit which generates benefit information related to a benefit to a user of the moving body determined by the stay determination unit to have stayed in the facility and determined by the charging determination unit to have not been charged by any of the one or more charging apparatuses for moving bodies.

2. The information management device according to claim 1, wherein
the benefit information generation unit is configured to create the benefit information on a required condition that all of the one or more charging apparatuses for moving bodies are used by one or more moving bodies that are each different from the moving body detected by the stay determination unit to have stayed in the facility.

3. The information management device according to claim 1, wherein
the benefit information is information for providing a benefit related to charging of a moving body.

4. The information management device according to claim 1, wherein
the stay determination unit determines whether the moving body has stayed in the facility based on positions of the moving body in a plurality of points of time.

5. The information management device according to claim 1, wherein
the stay determination unit determines whether the moving body has stayed in the facility based on a purchase history of a user of the moving body with respect to the facility.

6. An information management method executed by a computer that includes a facility information storage unit which stores facility information including at least a position of a facility, comprising:
a step of receiving moving body information that includes moving body identification information for identifying each of one or more moving bodies and moving body position information indicating a position of each of the one or more moving bodies;
a step of receiving charging state information indicating a charging state of a moving body by one or more charging apparatuses for moving bodies installed in the facility;
a step of determining whether the moving body has stayed in the facility based on the facility information and the moving body information;
a step of determining whether the moving body determined to have stayed in the facility has been charged by any of the one or more charging apparatuses for moving bodies based on the charging state information; and
a step of generating benefit information relating to a benefit to a user of the moving body determined to have stayed in the facility and determined to have not been charged by any of the one or more charging apparatuses for moving bodies.
